(19) United States
(12) Patent Application Publication
(10) Pub. No.: US 2025/0010496 A1
(43) Pub. Date: Jan. 9, 2025

(54) VACUUM ENABLED GRIPPER WITH ROLLER CONTACT FINGERS

(71) Applicant: Applied Materials, Inc., Santa Clara, CA (US)

(72) Inventor: Balasubramaniam CJ, Coimbatore (IN)

(73) Assignee: Applied Materials, Inc., Santa Clara, CA (US)

(21) Appl. No.: 18/218,979

(22) Filed: Jul. 6, 2023

(51) Int. Cl. B25J 15/08; B25J 9/14

(52) U.S. Cl. CPC B25J 15/08; B25J 9/14

(57) ABSTRACT

The present disclosure describes a substrate gripping clamp. The substrate gripping clamp includes a clamp arm and a roller recess disposed therein. The substrate gripping clamp also includes a gripper disposed within the roller recess and coupled to the clamp arm. The gripper further includes a top bevel face, a bottom bevel face, and a mid roller face between the top bevel face and the bottom bevel face.

### BACKGROUND

### Field

Embodiments of the present invention generally relate to a method of cleaning a substrate for semi-conductor manufacturing. In particular, methods and apparatus for minimizing contaminants during processing of semiconductor wafers are provided.

### Description of the Related Art

Substrate processing units perform cleaning operations prior to being packaged. The removal of contaminants during processing and packaging is always a focus in the semiconductor manufacturing industry. Contaminant removal is dependent on where the substrate is within the manufacturing process. Further, some cleaners used during cleaning operations are costly. Efforts to maximize the efficiency of cleaning fluid to thereby reduce cost are always a consideration. Thus, there is a need in the art for more efficient apparatus and methods of cleaning substrates while minimizing contaminants.

### SUMMARY

In one embodiment, a substrate gripping clamp is provided. The substrate gripping clamp includes a clamp arm and a roller recess disposed therein. The substrate gripping clamp includes a gripper disposed within the roller recess and coupled to the clamp arm. The gripper includes a top bevel face, a bottom bevel face, and a mid roller face between the top bevel face and the bottom bevel face.

In another embodiment, a substrate gripping clamp is provided. The substrate gripping clamp includes a clamp arm and a roller recess disposed therein. The substrate gripping clamp includes a vacuum channel disposed within the clamp arm and fluidly coupled to the roller recess. The substrate gripping clamp includes a gripper disposed within the roller recess and coupled to the clamp arm. The gripper includes a top bevel face configured to contact a substrate contact face of a substrate; a bottom bevel face, configured to contact a substrate contact face of the substrate; and a mid roller face between the top bevel face and the bottom bevel face.

In another embodiment, a chemical mechanical polishing (CMP) system is provided. The CMP system includes one or more cleaning modules. The CMP system includes a robot having a substrate clamp. The robot is in fluid communication with a vacuum system. The substrate clamp, includes a clamp arm and a roller recess disposed therein, a gripper disposed within the roller recess and coupled to the clamp arm. The gripper includes a top bevel face, a bottom bevel face, and a mid roller face between the top bevel face and the bottom bevel face.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the disclosure and are therefore not to be considered limiting of its scope, as the disclosure may admit to other equally effective embodiments.

FIG. 1 is a schematic illustration of a cleaning system according to some embodiments.

FIG. 2 is a schematic illustration of a clamp assembly of the cleaning system in FIG. 1 according to some embodiments.

FIG. 3 is a schematic illustration of a grip region of the clamp assembly of FIG. 2 according to some embodiments.

FIG. 4A is a schematic illustration of a side view of the grip region of FIG. 3 according to some embodiments.

FIG. 4B is a schematic illustration of a side view of the grip region of FIG. 3 according to some embodiments.

FIG. 5 is a schematic illustration of a grip region of the clamp assembly of FIG. 2 according to some embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Substrates, also known as wafers, are moved within different units for various stages during the semiconductor manufacturing process. Each unit may have one or more modules within each unit. Cleaning and packaging units and modules are particularly focused on minimizing contaminants between different operations in a unit. An apparatus used to transport a substrate between different modules within a unit is an area that has been improved by this disclosure. The following discussion includes new features that can be incorporated into a substrate moving apparatus that reduces the potential to transmit contaminants between different modules and operations of the semiconductor manufacturing process.

The following disclosure includes rollers and a vacuum system to minimize the contact area between a substrate moving apparatus and a substrate. The novel substrate moving apparatus includes one or more rollers that minimizes contact points and reduces the area in which contaminants may collect. Further, a vacuum system may work in conjunction with the substrate moving apparatus for active removal of contaminants, such as ceria, other hard particles, and particles with high densities.

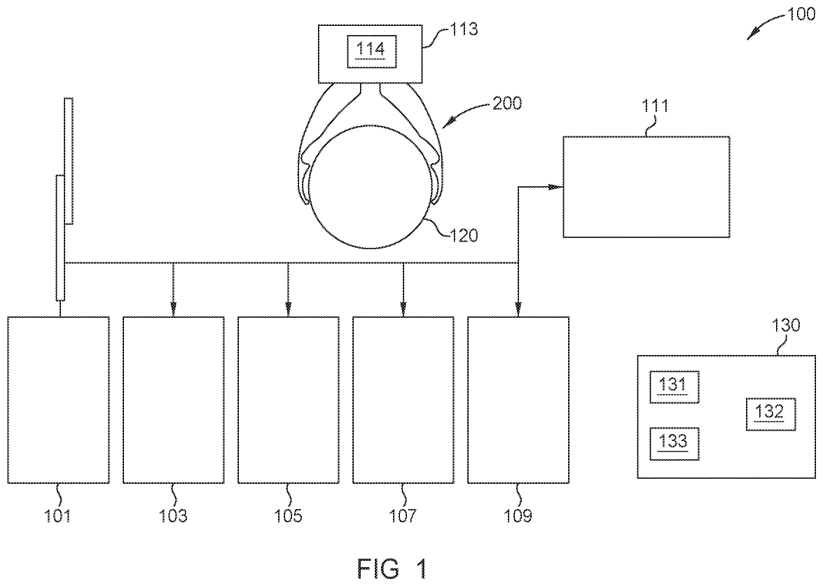

FIG. 1 illustrates a chemical mechanical polishing (CMP) system 100 for use in a semiconductor processing facility. The CMP system 100 includes one or more modules 101, 103, 105, 107, 109, 111. The modules 101, 103, 105, 107, 109, 111 are configured to perform various operations on a substrate 120. For example, the modules 101, 103, 105, 107, 109, 111 may be cleaning modules, packaging modules, etching modules, deposition modules, ultraviolet modules, polishing modules, or any combination thereof.

As illustrated in FIG. 1, the CMP system 100 also includes a system controller 130. In some embodiments, operations of the CMP system 100, are directed by the system controller 130. The system controller 130 includes a programmable central processing unit (CPU) 131 which is operable with a memory 132 (e.g., non-volatile memory) and support circuits 133. The support circuits 133 are conventionally coupled to the CPU 131 and comprise cache, clock circuits, input/output subsystems, power supplies, and the like, and combinations thereof coupled to the various components of the CMP system 100, to facilitate control thereof. The CPU 131 is one of any form of general purpose computer processor used in an industrial setting, such as a programmable logic controller (PLC), for controlling various components and sub-processors of the processing system. The memory 132, coupled to the CPU 131, is non-transitory and is typically one or more of readily available memories such as random access memory (RAM), read only memory (ROM), floppy disk drive, hard disk, or any other form of digital storage, local or remote.

Typically, the memory 132 is in the form of a non-transitory computer-readable storage media containing instructions (e.g., non-volatile memory), which when executed by the CPU 131, facilitates the operation of the CMP system 100. The instructions in the memory 132 are in the form of a program product such as a program that implements the methods of the present disclosure. The program code may conform to any one of a number of different programming languages. In one example, the disclosure may be implemented as a program product stored on computer-readable storage media for use with a computer system. The program(s) of the program product define functions of the embodiments (including the methods described herein).

Illustrative non-transitory computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory devices, e.g., solid state drives (SSD)) on which information may be permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the methods described herein, are embodiments of the present disclosure. In some embodiments, the methods set forth herein, or portions thereof, are performed by one or more application specific integrated circuits (ASICs), field-programmable gate arrays (FPGAs), or other types of hardware implementations. In some other embodiments, the substrate processing and/or handling methods set forth herein are performed by a combination of software routines, ASIC(s), FPGAs and, or, other types of hardware implementations. One or more system controllers 130 may be used with one or any combination of the various modular polishing and/or cleaning systems described herein and/or with the individual polishing modules thereof. The one or more system controllers 130 may be configured to maintain a vacuum without drying out the substrate 120.

As illustrated in FIG. 1, the CMP system 100 also includes a robot 113. The robot 113 includes a clamp assembly 200 and a vacuum system 114. The vacuum system 114 may be disposed within the robot 113 or a distance away. The clamp assembly 200 is coupled to the robot 113 and is configured to transfer and hold a substrate 120 between operations within the modules 101, 103, 105, 107, 109, 111. The robot 113 is configured to actuate the clamp assembly 200 by electrical, hydraulic means, pneumatic means, mechanical means, or any combination thereof. The robot 113 and clamp assembly 200 may be controlled by the controller 130 through wired or wireless connections.

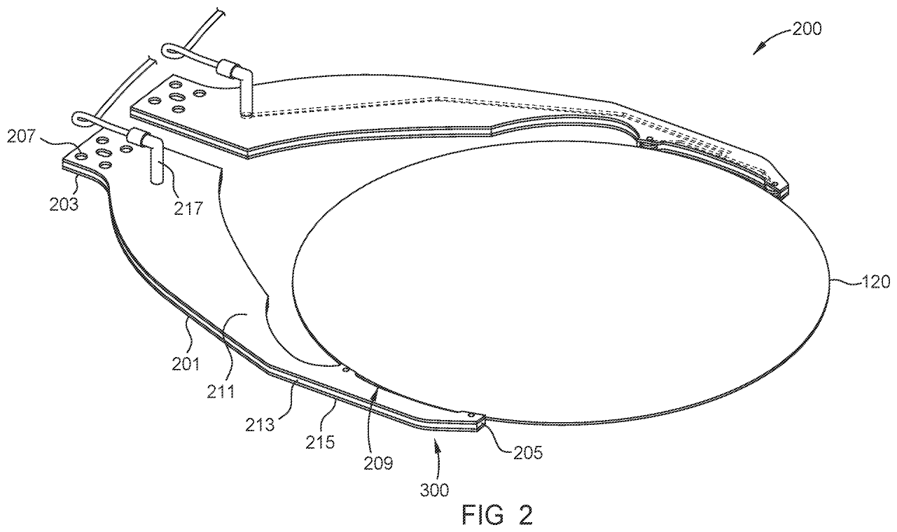

FIG. 2 illustrates the clamp assembly 200 according to some embodiments. The clamp assembly 200 may be a substrate gripping clamp. The clamp assembly 200 includes one or more clamp arms 201 (two shown). For example, in some embodiments two clamp arms 201 form a substrate clamp. In some embodiments, the clamp arms 201 are mirror images of each other and both actuate around the substrate 120. In other embodiments, one or more clamp arms 201 does not move and one or more other clamp arms 201 are actuated to contact the radial edge of the substrate 120. As shown, the clamp arm 201 includes a mounting end 203, a top plate 211, a mid-plate 213, and bottom plate 215. The mounting end 203 includes mounting features 207. The mounting features 207 are configured to couple the clamp arm 201 to the robot 113 (FIG. 1). The mounting features 207 may be one or more holes through the top plate 211, the mid-plate 213, the bottom plate 215. For example, the mounting features 207 may be five through holes with diameters between about 2 mm and about 20 mm. The mounting features 207 allow the clamp arm 201 to be coupled to the robot 113 and enable the robot 113 (FIG. 1) to move the clamp arm 201. For example, the robot 113 may use the clamp arm 201 to lift, move, and/or rotate the substrate 120. The top plate 211, the mid-plate 213, the bottom plate 215 may be separate plates according to some embodiments, but may be two plates in other embodiments. For example, the mid-plate 213 and the bottom plate 215 may be a single body. The plates 211, 213, 215, may be formed of a polymer, such as polyether ether ketone (PEEK), Polytetrafluoroethylene (PTFE), polyvinylidene fluoride (PVDF), Polyethylene terephthalate (PET), Polyphenylene sulfide (PPS), nylon, vinyl, polyurethane, polyethylene, or any combination thereof. Alternatively, the plates 211, 213, 215, may be formed of stainless steel, an alloy, a ceramic, or any combination thereof. The plates 211, 213, 215 may be secured together by a mechanical method, an adhesive, a thermal fusion process, or any combination thereof.

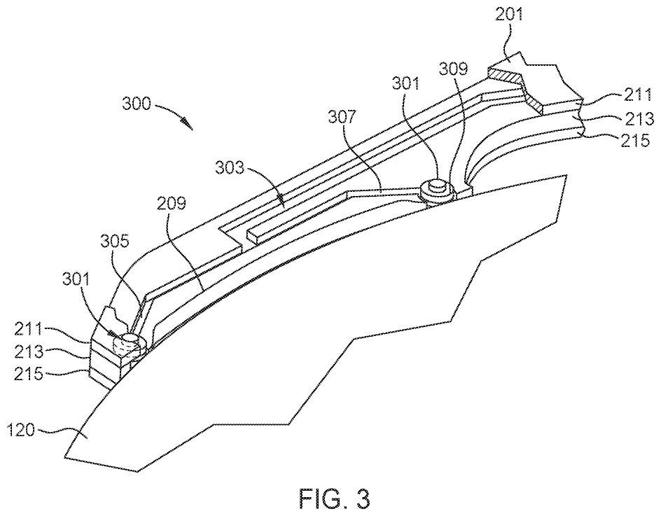

As illustrated in FIG. 2, the clamp arm 201 may also include a vacuum port 217. The vacuum port 217 is configured to fluidly couple the vacuum system 114 of the robot 113 to a vacuum channel 303 (FIG. 3) disposed within the clamp arm 201. Fluidly couples includes fluid communication between the vacuum system 114 to the vacuum channel 303. The vacuum channel 303 is discussed below. The vacuum port 217 may be a fitting, for example a NPT fitting, threaded through the top plate 211.

As illustrated in FIG. 2, the clamp arm 201 also includes a distal end 205 opposite the mounting end 203. A grip face 209 is proximate to the distal end 205 of the clamp arm 201. The grip face 209 faces the substrate 120. The grip face 209 is in a grip region 300 of the arm clamp 201.

FIG. 3 illustrates the grip region 300 according to some embodiments. The grip region 300 of the clamp arm 201 includes one or more grippers 301. For example, each clamp arm 201 includes two or more grippers 301. The grippers 301 are disposed within the clamp arm 201. The grip region 300 includes the vacuum channel 303 and one or more sub channels 305, 307. The vacuum channel 303 is fluidly coupled to the one or more sub channels 305, 307 and the vacuum port 217 (FIG. 2). The vacuum channel 303 and the one or more sub channels 305, 307 are fluidly coupled to the grippers 301. The vacuum channel 303 and the one or more sub channels 305, 307 are spaces disposed within the clamp arm 201. The vacuum channel 303 and the one or more sub channels 305, 307 are partially defined by the top plate 211, the bottom plate 215, and the grip face 209. The vacuum channel 303 and the one or more sub channels 305, 307 operate as an orifice such that any contaminants disposed on the grippers 301 are removed by the suction of the vacuum through the vacuum channel 303 and the one or more sub channels 305, 307.

As illustrated in FIG. 3, the vacuum channel 303 and the one or more sub channels 305, 307 enable a vacuum to be applied by the robot 113 (FIG. 1). The one or more sub channels 305, 307 include roller recesses 309 that partially surround each of the respective one or more grippers 301. Each of the one or more roller recesses 309 function as roller ports to fluidly couple the vacuum channel 303 to the substrate 120. In some embodiments, the grippers 301 partially protrude through the top plate 211 and the bottom plate 215.

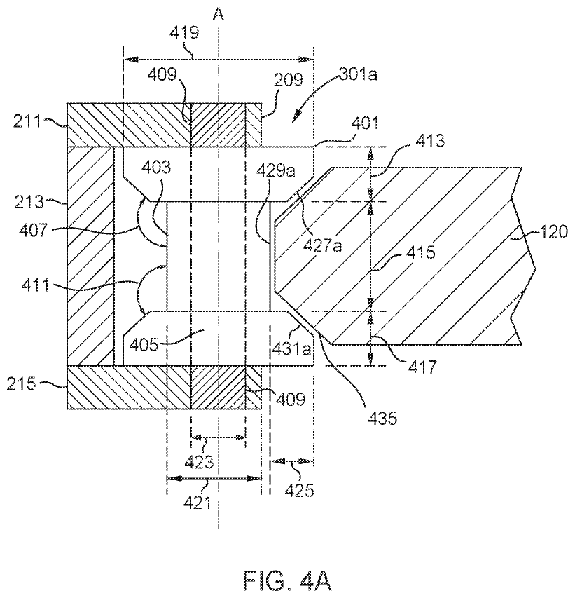

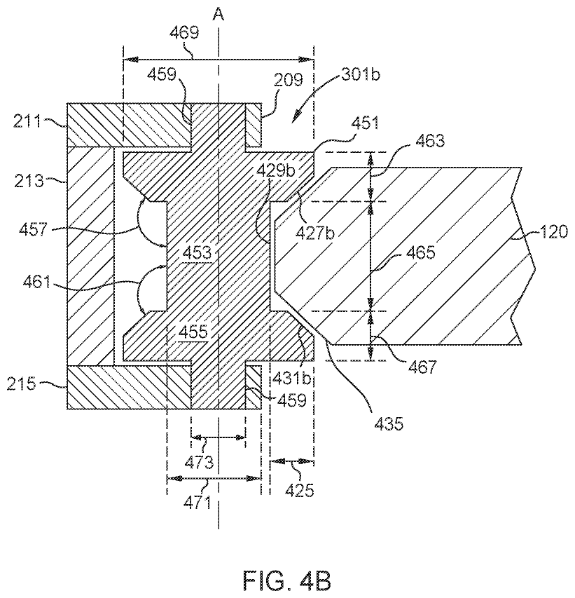

In some embodiments portions of the grippers 301 are stationary. In other embodiments, the grippers 301 are able to rotate when not in contact with the substrate 120 but not rotate when in contact with the substrate 120. In such embodiments, when the grippers 301 are not in contact with the substrate 120, the applied vacuum causes the grippers 301 to rotate and actively remove any contaminants on the gripper 301. When allowed to rotate, the recesses 309 allow for the vacuum to be applied around the gripper 301 and remove process fluid from a top bevel face 427, a mid roller face 429 and a bottom bevel face 431 (FIG. 4A). The faces 427, 429, 431 are discussed below.

FIG. 4A illustrates a cross section of one embodiment of the gripper 301 (i.e., gripper 301a) in the grip region 300 according to some embodiments. The gripper 301a includes a roller axis A, a top finger 401, a mid roller 403, a lower finger 405, and a pin 409. In some embodiments, the mid roller 403 includes PEEK, PTFE, PVDF, PET, PPS, nylon, vinyl, polyurethane, polyethylene, or any combination thereof. Alternatively, the mid roller 403, may be formed of stainless steel, an alloy, a ceramic, or any combination thereof. The material of the top finger 401, mid roller 403, and the lower finger 405 may include quartz, but other materials are contemplated. For example, the material of the top finger 401 and the lower finger 405 may include PEEK.

As illustrated in FIG. 4A, the top finger 401 has a height 413, a top bevel angle 407, the top bevel face 427a, and a diameter 419 and is centered about the roller axis A. In some embodiments, the top finger 401 is affixed to the top plate 211. For example, the top finger 401 is affixed to the top plate 211 with an adhesive. In other embodiments, the top finger 401 is part of the top plate 211. The diameter 419 of the top finger 401 is between about 2 mm and about 20 mm. For example, the diameter 419 is about 10 mm. The top finger height 413 is between about 2 mm and about 20 mm. For example, the top finger height 413 is about 10 mm. The top bevel angle 407 is the angle between the top bevel face 427a and the mid roller face 429a. The top bevel angle 407 is between about 100° and 160°, for example 135°. The top bevel face 427a is the face of the top finger 401 configured to contact the substrate 120.

As illustrated in FIG. 4A, the mid roller 403 has a height 415 and a diameter 421 and is centered about the roller axis A. The diameter 421 is between about 2 mm and about 15 mm. For example, the diameter 421 is about 8 mm. The mid roller height 415 is between about 2 mm and about 8 mm. For example, the mid roller height 415 about 4 mm. In some embodiments, the mid roller 403 is free to rotate about the pin 409 when not in contact with the substrate 120. For example, the vacuum created by the vacuum system causes the mid roller 403 to rotate and any contaminants are continuously removed from the mid roller 403.

As illustrated in FIG. 4A, the lower finger 405 has a height 417, a bottom bevel angle 411, and a diameter 419 and is also centered about the roller axis A. In some embodiments, the lower finger 405 is affixed to the bottom plate 215. For example, the lower finger 405 is affixed to the bottom plate 215 with an adhesive. In other embodiments, the lower finger 405 is part of the bottom plate 215. The lower finger height 417 is between about 2 mm and about 20 mm. For example, the lower finger height 417 is about 10 mm. In some embodiments, the top finger 401 and the lower finger 405 have about the same diameter 419. In other embodiments, the top finger 401 and the lower finger 405 have different diameters 419. The bottom bevel angle 411 is the angle between the bottom bevel face 431a and the mid roller face 429a. The bottom bevel angle 411 is between about 100° and 160°, for example 135°. The bottom bevel face 431a is the face of the lower finger 405 configured to contact the substrate 120. In some embodiments, the bevel angles 407, 411 are about equal. In some embodiments, the bevel angles 407, 411 are different angles.

As illustrated in FIG. 4A, the pin 409 has a diameter 423. The diameter 423 is between about 2 mm and about 10 mm. For example, the diameter 423 is about 5 mm. In some embodiments, the pin 409 extends through the top plate 211 and the bottom plate 215. In other embodiments, the pin 409 only partially extends into the top plate 211 and the bottom plate 215. The pin 209 may be formed with PEEK, PTFE, PVDF, PET, PPS, nylon, vinyl, polyurethane, polyethylene, or any combination thereof.

As illustrated in FIG. 4A, the top bevel face 427a and the bottom bevel face 431a are configured to minimally contact the beveled edges of the substrate 120 such that there is a point of contact between each face 427a, 431a and the substrate. This is an improvement over method of supporting a substrate when a whole planar surface or parallel line contacts the substrate 120. In the embodiments as depicted in FIG. 4A the mid roller 403 is able to rotate about the pin 409 while the top finger 401 and bottom finger 405 are stationary.

FIG. 4B illustrates a cross section of the gripper 301 (i.e., gripper 301b) in the grip region 300 according to some embodiments. The gripper 301a as described in FIG. 4A is similar to the gripper 301b as illustrated in FIG. 4B except that the gripper 301b as illustrated in FIG. 4B is one solid body. The gripper 301b includes a roller axis A, a top body 451, a mid body 453, a lower body 455, and pin bodies 459.

As illustrated in FIG. 4B, the top body 451 includes a height 463, a top bevel angle 457, the top bevel face 427b, and a diameter 469 and is centered about the roller axis A. The diameter 469 is between about 2 mm and about 20 mm. For example, the diameter 419 is about 10 mm. The top body height 463 is between about 2 mm and about 20 mm. For example, the top body height 463 is about 10 mm. The top bevel angle 457 is the angle between the top bevel face 427b and a mid roller face 429b. The top bevel angle 457 is between about 100° and 160°, for example 135°. The top bevel face 427b is the face of the top body 451 configured to contact the substrate 120.

As illustrated in FIG. 4B, the mid body 453 has a height 465 and a diameter 471 and is centered about the roller axis A. The diameter 471 is between about 2 mm and about 15 mm. For example, the diameter 471 is about 8 mm. The mid roller height 465 is between about 2 mm and about 8 mm. For example, the mid roller height 465 is about 4 mm.

As illustrated in FIG. 4B, the lower body 455 has a height 467, a bottom bevel angle 461, and the diameter 469 and is centered about the roller axis A. The lower body height 467 is between about 2 mm and about 20 mm. For example, the lower body height 467 is about 10 mm. In some embodiments, the top body 451 and the lower body 455 have about the same diameter 469. In other embodiments, the top body 451 and the lower body 455 have different diameters 469. The bottom bevel angle 461 is the angle between the bottom bevel face 431b and the mid roller face 429b. The bottom bevel angle 461 is between about 100° and 160°, for example 135°. The bottom bevel face 431b is the face of the lower body 455 configured to contact the substrate 120. In some embodiments, the bevel angles 457, 461 are about equal. In some embodiments, the bevel angles 457, 461 are different angles.

As illustrated in FIG. 4B, the pin bodies 459 have a diameter 473. The diameter 473 is between about 2 mm and about 10 mm. For example, the diameter 473 is about 5 mm. In some embodiments, the pin bodies 459 extend through the top plate 211 and the bottom plate 215. In other embodiments, the pin bodies 459 only partially extend into the top plate 211 and the bottom plate 215.

As illustrated in FIG. 4B, the top bevel face 427b and the bottom bevel face 431b are configured to minimally contact the beveled edges of the substrate 120 such that there is about a point of contact between each face 427b, 431b and the substrate. This is an improvement over method of supporting a substrate when a whole planar surface or parallel line contacts the substrate 120. In the embodiments as depicted in FIG. 4B the whole gripper 301b is able to rotate about the roller axis A.

As illustrated in FIGS. 4A and 4B, the gripper 301 minimizes overhang, also known as overshadowing. Overhang is the distance 425 that a planar surface extends from the gripper 301 over substrate contact faces 435. The substrate contact faces 435 include a top contact face and bottom contact face of the substrate. The overhang enables the surface tension of process fluids to deposit contaminants on a surface proximate to the substrate 120. If not cleaned, the contaminants can build up and transfer between substrates 120. In some embodiments, the faces 427a, 431a, 427b, 431b are curved such that the gripper 301 includes curvatures. The curvature of the grippers 301 minimizes surfaces where surface tension from the process fluid can deposit contaminants and enables single points of contact instead of planar contact. The illustrated configurations and disclosed embodiments reduce the locations contaminants can dry and cling when compared to other configurations. In all embodiments, the gripper is able to grip a substrate 120 even if not perfectly aligned with the clamp assembly 200 due to the bevel angles 407, 411, 457, 461. For example, the bevel angles 407, 411, 457, 461 enable the clamp assembly 200 to pick up a substrate 120 in a vertical brush box even if the substrate 120 is titled.

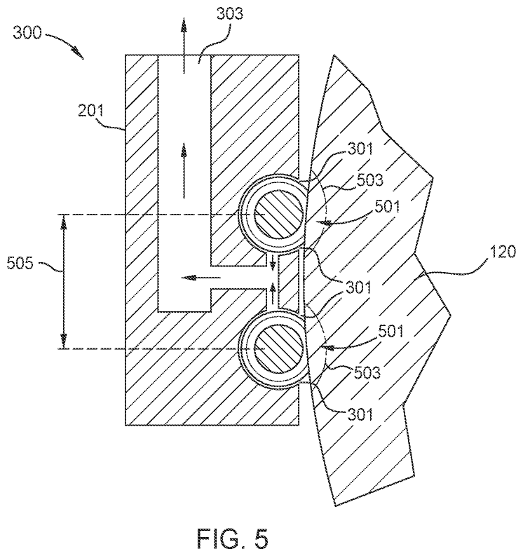

FIG. 5 shows a schematic illustration of the clamp arm 201 when a vacuum is applied. When cleaning the substrate 120, process fluids are applied to the substrate 120 to remove contaminants. The substrate 120 is held in place by the clamp assembly 200 when the process fluids are applied. The vacuum system provides a suction 501 such that process fluid that translates to a suction region 503. The suction regions 503 are near the grippers 301. Process fluid that translates to a suction region 503 will, instead of falling off the edge of the substrate, be sucked past the grippers 301 and into the vacuum sub channels 305, 307. The vacuum system 114 is tuned such that velocity of air traveling over the substrate 120 is less than about 7 m/s. For example, as the vacuum system is providing suction to clamp assembly 200, the suction regions 503 near the grippers 301 travels less than 5 m/s. This low velocity helps to keep an area near the grippers 301 from drying out during cleaning operations. The grippers 301 are spaced a distance 505 from the gripper 301 centers. For example, the distance 505 between the grippers 301 may be between about 30 mm to about 100 mm. For example, the distance 505 between the grippers 301 may be between about 40 mm to about 90 mm. For example, the distance 505 between the grippers 301 may be about 85 mm.

In some embodiments, the vacuum system provides a vacuum to the vacuum port 217 between about −1 atm to about −0.8 atm, for example, −0.9 atm. This enables the area proximate to the grippers 301 to experience a vacuum between about −0.6 atm and about −0.01 atm. For example, the area proximate to the grippers 301 experiences a vacuum of about −0.1 atm.

The above mentioned novel rollers and vacuum system aid in minimizing the contact points between a substrate moving apparatus and a substrate. These improvements help to prevent contamination of substrates and enhance the throughput of a semiconductor manufacturing process. The new features give the industry to retrofit an existing substrate moving apparatus with the disclosed system to further reduce potential point of issue that would otherwise slow down a manufacturing process.

What is claimed is:

1. A substrate gripping clamp, comprising:
a clamp arm and a roller recess disposed therein; and
a gripper disposed within the roller recess and coupled to the clamp arm, the gripper comprising:
a top bevel face;
a bottom bevel face; and
a mid roller face between the top bevel face and the bottom bevel face.

2. The clamp of claim 1, further comprising a vacuum channel disposed within the clamp arm.

3. The clamp of claim 2, wherein the vacuum channel fluidly couples a roller port of the clamp arm to a vacuum port of the clamp arm.

4. The clamp of claim 1, wherein the clamp comprises two clamp arms.

5. The clamp of claim 1, wherein the clamp comprises two or more grippers.

6. The clamp of claim 1, wherein the clamp is configured to contact a substrate at a point on the top bevel face and a point on the bottom bevel face.

7. The clamp of claim 1, wherein the top bevel face and bottom bevel face partially extend past a substrate contact face.

8. A substrate gripping clamp, comprising:
a clamp arm and a roller recess disposed therein;
a vacuum channel disposed within the clamp arm and fluidly coupled to the roller recess; and
a gripper disposed within the roller recess and coupled to the clamp arm, the gripper comprising:
a top bevel face configured to contact a substrate contact face of a substrate;
a bottom bevel face, configured to contact a substrate contact face of the substrate; and
a mid roller face between the top bevel face and the bottom bevel face.

9. The clamp of claim 8, wherein the clamp comprises two clamp arms.

10. The clamp of claim 8, wherein the clamp comprises two or more gripper.

11. The clamp of claim 8, wherein the top bevel face and the bottom bevel face are angled from a roller axis at different angles.

12. The clamp of claim 8, wherein the gripper further comprises quartz.

13. A chemical mechanical polishing (CMP) system, comprising:
one or more cleaning modules;
a robot comprising a substrate clamp, the robot in fluid communication with a vacuum system, the substrate clamp, comprising:
a clamp arm and a roller recess disposed therein; and
a gripper disposed within the roller recess and coupled to the clamp arm, the gripper comprising:
a top bevel face;
a bottom bevel face; and
a mid roller face between the top bevel face and the bottom bevel face.

14. The CMP system of claim 13, further comprising a vacuum channel disposed within the clamp arm and in fluid communication with the vacuum system.

15. The CMP system of claim 14, wherein the vacuum channel fluidly couples a roller port of the clamp arm to a vacuum port of the clamp arm.

16. The CMP system of claim 15, further comprising a controller, the controller configured to maintain a vacuum to remove contaminants from the gripper without drying a surface of a substrate in contact with the gripper.

17. The CMP system of claim 13, wherein the clamp comprises two or more grippers.

18. The CMP system of claim 13, wherein the clamp is configured to contact a substrate at a point on the top bevel face and a point on the bottom bevel face.

19. The CMP system of claim 13, wherein the top bevel face and bottom bevel face partially extend past a substrate contact face.

20. The CMP system of claim 13, wherein the gripper is configured to be able to rotate when not in contact with a substrate.
